(19) United States
(12) Patent Application Publication
(10) Pub. No.: US 2003/0221539 A1
(43) Pub. Date: Dec. 4, 2003

(54) Friction-resisting noise-eliminating rod member mounting arrangement for wind instrument

(76) Inventor: Wen-Hsu Chang, Taiping City (TW)

Correspondence Address: CHARLES E. BAXLEY, ESQUIRE, Hart, Baxley, Daniels & Holton, 5 Fl, 59 John St., New York, NY, 10038, US

(21) Appl. No.: 10/158,647

(22) Filed: May 31, 2002

(51) Int. Cl. G10D 7/08

(52) U.S. Cl. 84/385 A

(57) ABSTRACT

A friction-resisting noise-eliminating rod member mounting arrangement in which two friction bushings are respectively fitted into a respective recessed round hole in each of the two ends of a rod member, which controls the opening/closing of sound holes of the wind instrument, and coupled to a respective screw rod in each of two supports adapted to support the rod member on the body of the wind instrument.

### BACKGROUND OF THE INVENTION

1. Field of the Invention

The present invention relates to wind instruments and, more particularly, to a rod member mounting arrangement for wind instrument that produces little friction and noises during the operation of the wind instrument.

2. Description of the Related Art

A brass wind instrument, for example a saxophone has a set of sound holes. Each sound hole is matched with a normal-close or normal-open keypad. When the player pressed one key of the saxophone, the corresponding rod member is force to move the attached keypad to close or open the corresponding sound hole. FIGS. 1 through 3 show a rod member mounting arrangement for wind instrument according to the prior art. As illustrated, two supports are mounted on the body of the saxophone, and two screws are respectively mounted in a respective countersunk screw hole in the spherical head of each support to hold a rod member between the supports. The rod member is mounted with wind instrument elements, for example, keypad, key, key lever, actuating rod, etc. when the player of the saxophone pressed one key, the corresponding rod member is rotated between the respective supports through an angle, causing the attached wind instrument elements of the corresponding rod member to close/open the corresponding sound holes. Because the supports and the rod member are metal members, rotation of the rod member relative to the supports and the screws in the supports may cause friction noises when the rod member or the screws start to wear.

### SUMMARY OF THE INVENTION

The present invention has been accomplished under the circumstances in view. It is the main object of the present invention to provide a rod member mounting arrangement for wind instrument, which eliminates friction noises during the performance of the wind instrument. It is another object of the present invention to provide a rod member mounting arrangement for wind instrument, which greatly prolongs the service life of the wind instrument. To achieve these and other objects of the present invention, the friction-resisting noise-eliminating rod member mounting arrangement comprises a metal rod member, said rod member having two recessed round holes respectively disposed in the two distal ends thereof and extended in axial direction, two bushings of friction material respectively fitted into the recessed round holes of said rod member, two supports respectively mounted on the body of a wind instrument, and two metal screws respectively fastened to said supports and engaged into said bushings to hold said rod member between said supports.

### BRIEF DESCRIPTION OF THE DRAWINGS

FIG. 1 is an exploded view of a rod member mounting arrangement for wind instrument according to the prior art.

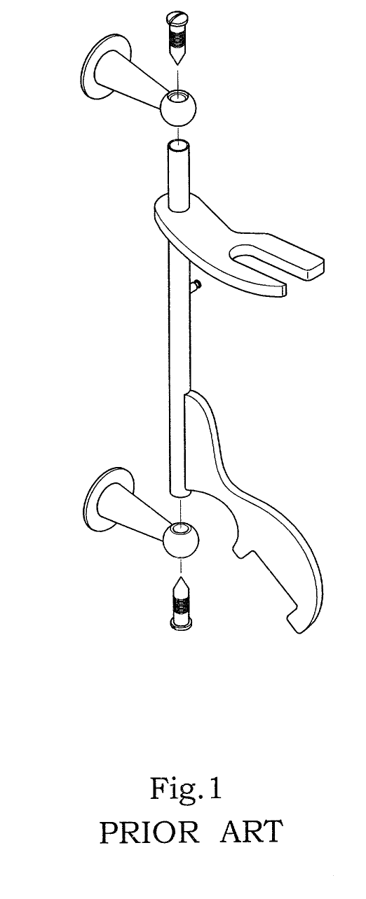

FIG. 2 is a sectional assembly view of the rod member mounting arrangement for wind instrument according to the prior art.

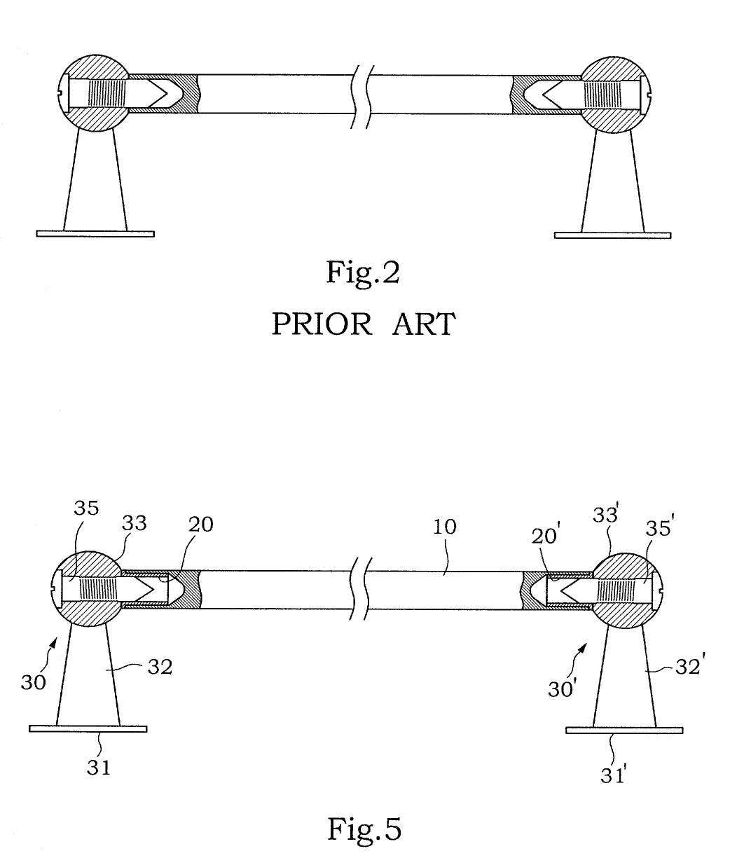

FIG. 3 is an elevational view of a regular saxophone. FIG. 4 is an exploded view of a rod member mounting arrangement for wind instrument according to the present invention.

FIG. 5 is a sectional assembly view of the rod member mounting arrangement for wind instrument according to the present invention.

FIG. 6 shows one application example of the present invention.

FIG. 7 shows another application example of the present invention.

FIG. 8 shows still another application example of the present invention.

FIG. 9 shows still another application example of the present invention.

### DETAILED DESCRIPTION OF THE PREFERRED EMBODIMENT

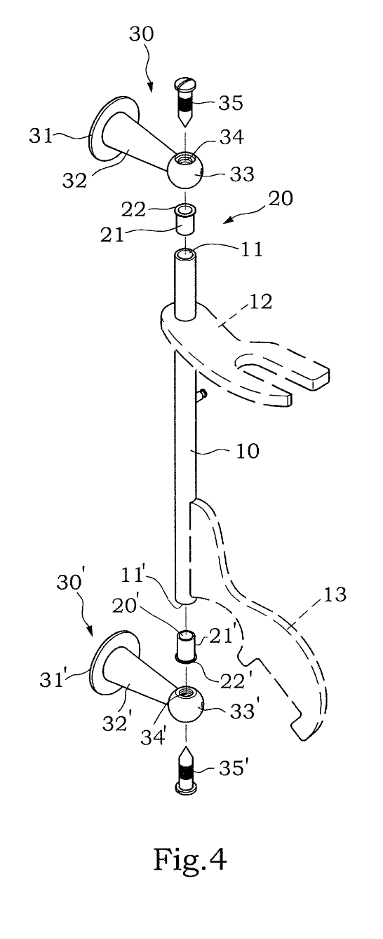

Referring to FIGS. 4 and 5, a friction-resisting noise-eliminating rod mounting arrangement for wind instrument in accordance with the present invention is shown comprised of:

a metal rod member 10, the rod member 10 having two recessed round holes 11;11′ respectively disposed in the two distal ends thereof and extended in axial direction;

two bushings 20;20′ made of friction material (for example, friction rubber), the bushing 20;20′ each comprising a tubular body 21 or 21′ fitted into one recessed round hole 11 or 11′ of the rod member 10, and a stop flange 22 or 22′ extended around the periphery of one end of the tubular body 21 or 21′ and stopped at one end of the rod member 10 outside the corresponding recessed round hole 11 or 11′;

two supports 30;30′ adapted to support the rod member 10 therebetween, the supports 30;30′ each comprising a thin sheet of mounting base 31 or 31′ fastened to the body of the wind instrument, for example, saxophone, a conical shank 32 or 32′ perpendicularly extended from the center of the mounting base 31 or 31′, a spherical head 33 or 33′ integral the thinnest end of the conical shank 32 or 32′, and a countersunk screw hole 34 or 34′ extended through the spherical head 33 or 33′ in direction perpendicular to the axis of the conical shank 32 or 32′; and

two metal screws 35 respectively threaded into the countersunk screw holes 34;34′ of the supports 30;30′ and engaged into the tubular bodies 21;21′ of the bushings 20;20′ in the recessed round holes 11;11′ of the rod member 10.

The inner diameter of the tubular bodies 21;21′ of the bushings 20;20′ is approximately equal to the outer diameter of the screws 35;35′. Because the bushings 20;20′ are made of friction material and respectively coupled between the recessed round holes 11;11′ of the rod member 10 and the screws 35;35′ in the countersunk screw holes 34;34′ of the supports 30;30′, they prevent direct friction between the metal rod member 10 and the metal screws 35;35′, eliminating the occurrence of friction noises due. The friction resisting material property of the bushings 20;20′ greatly prolong the service life of the rod member 10. Further, because the stop flanges 22;22′ of the bushings 20;20′ are stopped between the spherical heads 33;33′ of the supports 30;30′ and the ends of the rod member 10, the bushings 20;20′ prevent friction between the supports 30;30′ and the rod member 10.

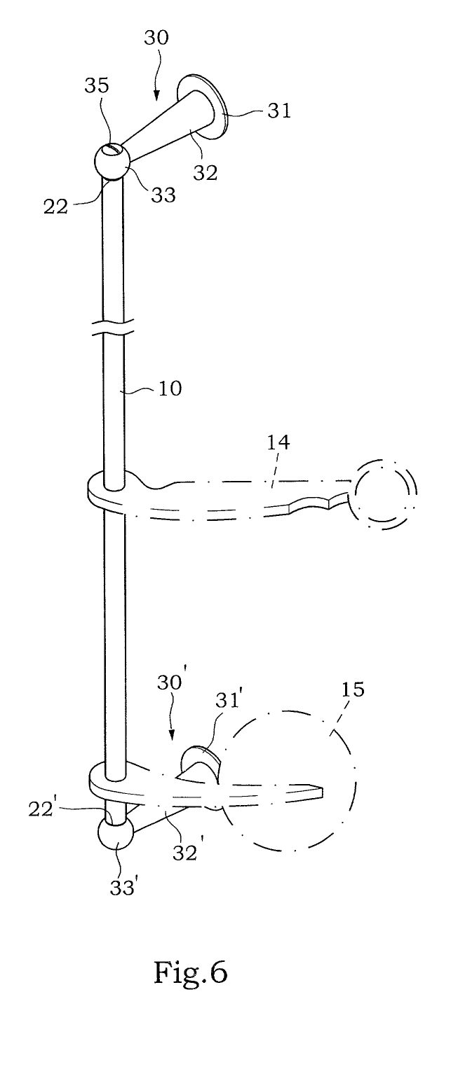

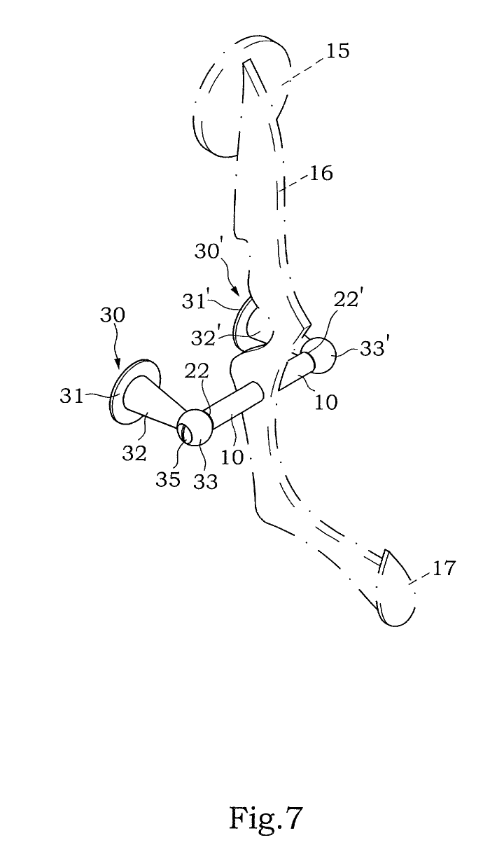

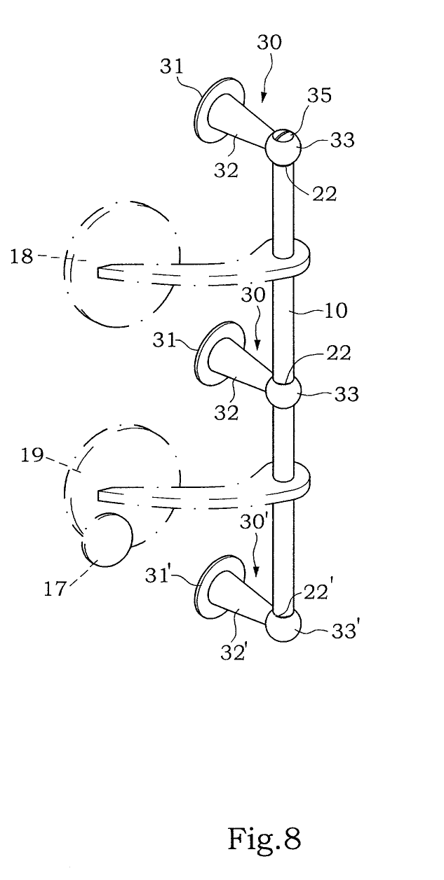

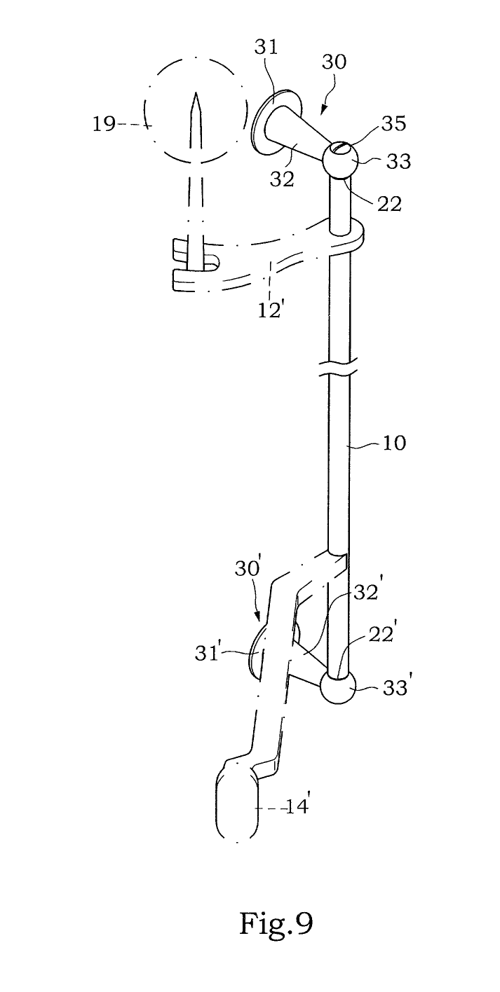

The aforesaid bushings 20;20′ can be used in the mounting of every rod member 10 of any of a variety of wind instruments, which rod member 10 may be mounted with any of a variety of fingerplates, plates, keypads, ring keys, etc. For example, in FIG. 4, the rod member 10 is mounted with an actuating rod 12 and a fingerplate 13; in FIG. 6, the rod member 10 is mounted with a fingerplate 14 and a keypad 15; in FIG. 7, the rod member 10 is mounted with a lever 16, which has a fingerplate 17 at one end and a keypad 15 at the other end; in FIG. 8, the rod member 10 is mounted with two keypads 18;19 and a ring key 17 at one keypad 19; in FIG. 9, the rod member 10 is mounted with a key 14′ and an actuating rod 12′ having an attached keypad 19.

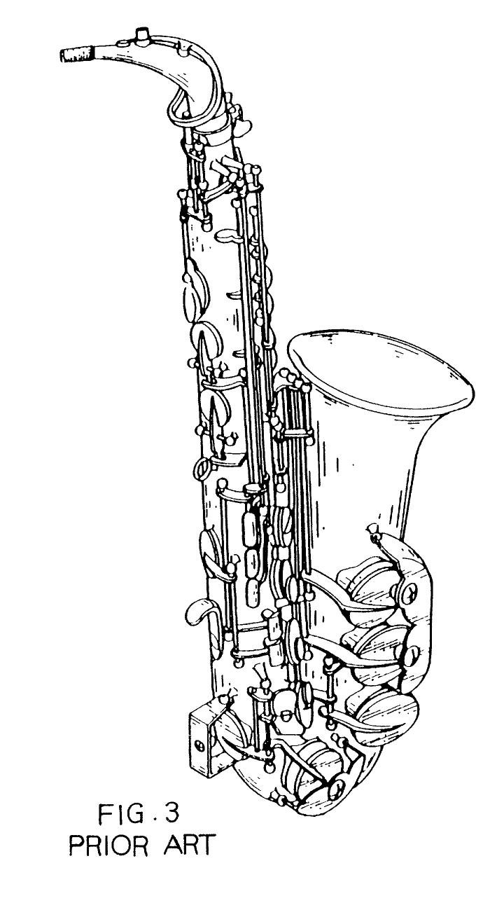

The saxophone, as shown in FIG. 3, has sound holes and normal-close or normal-open keypads matching the sound holes. In order to fit the locations of the sound holes and the performance of the fingers, the rod members, the actuating rods, the fingerplates, and the keypads have different shapes and are extended in different directions. However, friction bushings are respectively coupled between the respective rod members and the respective screws in the respective supports to eliminate friction noises.

A prototype of friction-resisting noise-eliminating rod member mounting arrangement has been constructed with the features of the annexed drawings of FIGS. 4˜9. The friction-resisting noise-eliminating rod member mounting arrangement functions smoothly to provide all of the features discussed earlier.

While only one embodiment of the present invention has been shown and described, it will be understood that various modifications and changes could be made thereunto without departing from the spirit and scope of the invention disclosed.

What the invention claimed is:

1. A friction-resisting noise-eliminating rod member mounting arrangement comprising two supports respectively mounted on the body of a wind instrument, a rod member, and two screws respectively fastened to said supports to hold said rod member between said supports for enabling said rod member to be rotated relative to said supports; wherein said rod member has two recessed round holes respectively disposed in two distal ends thereof and extended in axial direction; two bushings of flexible friction material are respectively fitted into the recessed round holes of said rod member and sleeved onto said screws to support said rod member on said screws between said supports.

2. The friction-resisting noise-eliminating rod member mounting arrangement as claimed in claim 1, wherein said bushings each comprise a tubular body fitted into one recessed round hole of said rod member.

3. The friction-resisting noise-eliminating rod member mounting arrangement as claimed in claim 2, wherein the outer diameter of said bushings is approximately equal to the inner diameter of said recessed round holes.

4. The friction-resisting noise-eliminating rod member mounting arrangement as claimed in claim 3, wherein the inner diameter of the tubular bodies of said bushings is approximately equal to the outer diameter of said screws.

5. The friction-resisting noise-eliminating rod member mounting arrangement as claimed in claim 3, wherein said bushings each further comprise a stop flange extended around the periphery of one end of the respective tubular body and stopped between one end of said rod member and one of said supports.
